(19) United States
(12) Patent Application Publication
(10) Pub. No.: US 2026/0341150 A1
(43) Pub. Date: Oct. 29, 2026

(54) METHOD AND DEVICE FOR GENERATING A ROAD MAP INFORMATION

(71) Applicants: HYUNDAI MOTOR COMPANY, Seoul (KR); KIA CORPORATION, Seoul (KR)

(72) Inventor: Ye Jun KIM, Hwaseong-si (KR)

(21) Appl. No.: 19/659,340

(22) Filed: Apr. 27, 2026

(30) Foreign Application Priority Data
Apr. 29, 2025 (KR) 10-2025-0055940

(51) Int. Cl. G08G 1/01; B60W 60/00

(52) U.S. Cl. CPC G08G 1/0141; B60W 60/0027; G08G 1/0125; B60W 2556/45

(57) ABSTRACT

Disclosed herein a method and device for generating a road map information. The method includes: generating clusters by performing clustering of representative points based on heading data of a representative region having a representative point selected from trajectory data of a plurality of vehicles; generating, based on the heading data of the representative point in the clusters, connectivity information of the clusters indicating connection or separation between the clusters; generating, based on the connectivity information, a segment by grouping the clusters; generating, based on the connectivity information of the clusters in the segment, road information including driving direction information of a road corresponding to the segment; and generating, based on the road information, road map information.

### CROSS-REFERENCE TO RELATED APPLICATION

This application claims the benefit of priority to Korean Patent Application No. 10-2025-0055940, filed in the Korean Intellectual Property Office on Apr. 29, 2025, the disclosure of which is incorporated herein by reference in its entirety.

### TECHNICAL FIELD

The present disclosure relates to a method and apparatus for generating road map information, and more particularly, to a method and apparatus that accurately generate various types of road information based on route data to support vehicle driving.

### BACKGROUND

The matters described in this Background section are only for enhancement of understanding of the background of the disclosure, and should not be taken as acknowledgment that they correspond to prior art already known to those skilled in the art.

Autonomous driving functions may enable a vehicle to control their own driving while minimizing or completely excluding driver intervention.

The autonomous driving functions may be designed in such a way that the vehicle may recognize the road environment and control the driving on its own, with minimal or complete exclusion of direct intervention by the driver. In order to implement the autonomous driving functions, supporting technologies such as recognition of the surrounding environment and high-precision map data may be integrated into the vehicle, so that the vehicle may operate stably even in complex traffic situations.

In autonomous driving, precise lane-level maps may be utilized to accurately locate vehicles in real-time, plan appropriate driving routes according to the structure of the road and traffic flow, and ensure safe and efficient operation.

Precision maps may be created based on road information based on the vehicle's drive path but may include road information that merely indicates whether a lane of the road exists. Such road information may not reflect the detailed characteristics of the road and thus may not support decisions and processing performed by the autonomous driving system in an actual road environment.

### SUMMARY

Various examples of the present disclosure are to provide a method and apparatus that accurately generate various types of road information based on route data to support vehicle driving.

Various examples to be solved by the present disclosure are not limited to those mentioned above, and other problems not mentioned will be clearly understood by those of ordinary skill in the art from the following description.

According to the present disclosure, a method performed by an apparatus for a vehicle may comprise performing, based on heading data associated with a plurality of representative regions, clustering of representative points to generate clusters, wherein each representative region may comprise a representative point selected from trajectory data obtained from a plurality of vehicles including the vehicle, generating, based on the heading data, connectivity information indicating connection or separation between the clusters, grouping, based on the connectivity information, the clusters to generate a segment, generating, based on pieces of the connectivity information associated with the segment, road information that may comprise driving direction information of a road corresponding to the segment, generating, based on the road information, road map information, transmitting, to the vehicle, the road map information, and causing, based on the transmitted road map information, execution of autonomous driving control of the vehicle.

According to the present disclosure, a system may comprise one or more computing devices including a communication interface configured to receive trajectory data obtained from a plurality of vehicles, a processor, and a memory storing at least one instruction that, when executed by the processor, is configured to cause the system to determine, based on the trajectory data, representative points, generate, based on the representative points, representative regions, group, based on heading data associated with the representative points, the representative regions to generate clusters, generate, based on the heading data, connectivity information indicating connection or separation between the clusters, generate, based on the connectivity information, at least one segment by grouping the clusters, generate, based on the at least one segment, road information, generate, based on the road information, road map information, transmit, to at least one of the plurality of vehicles, the road map information, and cause, based on the transmitted road map information, autonomous driving control of the at least one of the plurality of vehicles.

The at least one instruction, when executed by the processor, is configured to cause the system to identify, for each of the representative regions, a representative point based on a central position of tracking points included in the trajectory data and heading data associated with the tracking points.

The at least one instruction, when executed by the processor, is configured to cause the system to determine, based on different heading directions associated with the representative points, the connectivity information.

The at least one instruction, when executed by the processor, is configured to cause the system to generate the at least one segment by grouping clusters that are connected based on the connectivity information.

According to the present disclosure, an apparatus for a vehicle may comprise a processor and a memory storing at least one instruction that, when executed by the processor, is configured to cause the apparatus to perform, based on heading data associated with a plurality of representative regions, clustering of representative points to generate clusters, wherein each representative region may comprise a representative point selected from trajectory data obtained from a plurality of vehicles including the vehicle, generate, based on the heading data, connectivity information indicating connection or separation between the clusters, group, based on the connectivity information, the clusters to generate a segment, generate, based on pieces of the connectivity information associated with the segment, road information that may comprise driving direction information of a road corresponding to the segment, generate, based on the road information, road map information, transmit, to the vehicle, the road map information, and cause, based on the transmitted road map information, execution of autonomous driving control of the vehicle.

The representative point may be one of tracking points associated with the corresponding representative region, the tracking points may be arranged in the trajectory data at a predetermined interval, and the at least one instruction, when executed by the processor, is configured to cause the apparatus to identify a central position for each of the plurality of representative regions, generate average heading data of the tracking points, wherein the average heading data may comprise an average heading angle for each of the plurality of representative regions, identify, for each of the plurality of representative regions, a tracking point that intersects a virtual line perpendicular to the average heading angle of the corresponding representative region, and group, based on the identified tracking points, the plurality of representative regions to generate the clusters.

The at least one instruction, when executed by the processor, is configured to cause the apparatus to identify, from a plurality of tracking points that intersect the virtual line, the tracking point based on a distance between closest points of adjacent representative regions being less than or equal to a threshold distance and a difference in an average directing angle between the adjacent representative regions being less than or equal to a threshold angle.

The at least one instruction, when executed by the processor, is configured to cause the apparatus to identify, for each of the representative points in the clusters, a forward cluster in a heading direction associated with heading data of the representative point and a backward cluster in a direction different from the heading direction, update the connectivity information, based on at least one of the forward cluster or the backward cluster corresponding to a neighboring cluster, to indicate the connection between the clusters, update the connectivity information, based on at least one of the forward cluster or the backward cluster not corresponding to a neighboring cluster, to indicate the separation between the clusters, and record, in the connectivity information, the forward cluster and the backward cluster based on at least one of an identifier of an adjacent cluster neighboring the representative point, an identifier of a cluster in which the representative point is included, or a disconnection identifier.

The at least one instruction, when executed by the processor, is configured to cause the apparatus to generate the segment by grouping the clusters based on the connectivity information indicating the connection between the clusters.

The at least one instruction, when executed by the processor, is configured to cause the apparatus to generate a center line passing through centers of the clusters in the segment, generate, based on the connectivity information, driving directions of the representative points, wherein the representative points are arranged on both sides of the center line, and generate, based on the driving directions, driving direction information of the road corresponding to the representative points.

The road information may comprise U-turn information corresponding to the segment, and the at least one instruction, when executed by the processor, is configured to cause the apparatus to generate, based on the connectivity information, the U-turn information.

The road information may comprise intersection information, and the at least one instruction, when executed by the processor, is configured to cause the apparatus to generate, based on a cluster arranged at an end of the segment, the intersection information.

The at least one instruction, when executed by the processor, is configured to cause the apparatus to generate, for a plurality of segments generated from the clusters, a plurality of sets of clusters, wherein each set may comprise clusters arranged at ends of a corresponding segment, and determine, based on an overlap of the plurality of sets of clusters, the intersection information, wherein the intersection information indicates an intersection region.

The at least one instruction, when executed by the processor, is configured to cause the apparatus to postprocess the intersection information to remove, from the plurality of sets of clusters, clusters that overlap the intersection region.

The features briefly summarized above for this disclosure are only examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example of modules constituting the apparatus for generating the road map information;

FIG. 2 shows an example of a method of generating the road map information;

FIG. 3 shows an example of generation of the trajectory data by the preprocessing of the route data;

FIG. 4 shows an example of selection of a representative point in the trajectory data;

FIG. 5 shows an example of a cluster;

FIG. 6 shows an example of connectivity information;

FIG. 7 shows an example of a segment;

FIG. 8 shows an example of generation of road information;

FIG. 9 shows an example of a method of generating the road map information;

FIGS. 10A and 10B show an example of estimation of intersection information;

FIG. 11 shows an example of postprocessing of intersection information;

FIG. 12 shows an example that a vehicle communicates with another device to transmit and receive data;

FIG. 13 shows an example of a module constituting a vehicle; and

FIG. 14 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be controlled based on the feature of generating road map information by aggregating trajectory data obtained from multiple vehicles. For example, when the aggregated trajectory data identifies a zone where many vehicles reduce speed—such as near a sharp curve, narrowed lane, or frequent roadwork area—the autonomous driving control may automatically adjust speed limits, modify acceleration profiles, or increase following distance. Likewise, if aggregated data reveals consistent lane-keeping patterns or common merging behaviors across multiple vehicles, the system may optimize steering control, braking timing, or collision-warning thresholds to match these safer collective driving trends.

One or more auxiliary devices (e.g., engine brake, exhaust brake, hydraulic retarder, electric retarder, regenerative brake, etc.) may also be controlled based on the feature of generating road map information by aggregating trajectory data obtained from multiple vehicles. For example, when the aggregated trajectory data indicates a downhill segment where many vehicles apply strong deceleration, the auxiliary brakes may be pre-activated or increased in strength to maintain stability. Likewise, if aggregated data reveals frequent stop-and-go behavior near a merging bottleneck or repeated heavy braking before a sharp curve, the auxiliary devices may smooth deceleration, optimize energy recovery, or reduce load on the primary brakes to improve safety and efficiency.

One or more communication devices (e.g., a modem, a network adapter, a radio transceiver, an antenna, etc.) may also be controlled based on the feature of generating road map information by aggregating trajectory data obtained from multiple vehicles. For example, when aggregated trajectory data indicates an upcoming region with poor connectivity, such as a tunnel or dense urban canyon, the communication device may preload road map updates or increase transmission priority for safety-critical messages before entering the area. Likewise, when aggregated data identifies road segments where vehicles frequently exchange hazard information, for instance, near sharp curves or merging zones, the communication device may increase V2X broadcast frequency or enable extended-range communication to ensure timely sharing of warnings.

Minimum risk maneuver (MRM) operation(s) may also be controlled based on the feature of generating road map information by aggregating trajectory data obtained from multiple vehicles. For example, when the aggregated trajectory data indicates a frequently reported hazard area, such as a sharp curve where many vehicles slow abruptly, the vehicle may trigger an MRM earlier to reach a safer state. Likewise, if the aggregated data reveals common stopping zones—for instance, where multiple vehicles consistently pull over during sudden congestion or near a known merging bottleneck—the MRM operation may guide the vehicle to those safer pull-over regions. In addition, when aggregated data shows limited shoulder availability or narrow lanes, the MRM may adjust deceleration rates or lane-stabilizing actions to reduce collision risk.

Biased driving operation(s) may also be controlled based on the feature of generating road map information by aggregating trajectory data obtained from multiple vehicles. For example, when the aggregated trajectory data shows that many vehicles tend to shift slightly left on a particular curve or keep a wider offset near a frequently parked-vehicle zone, the driving control apparatus may adjust the biased lateral distance accordingly to improve stability and safety. Likewise, if aggregated data indicates that vehicles commonly maintain a larger right-side gap on narrow roads or avoid the lane center near worn lane markings, the biased driving control may modify the target lateral distance to mimic these safer collective driving patterns.

One or more sensors (e.g., IMU sensors, camera, LIDAR, RADAR, blind spot monitoring sensor, line-departure warning sensor, parking sensor, rain sensor, traction control sensor, etc.) may also be controlled based on the feature of generating road map information by aggregating trajectory data obtained from multiple vehicles. For example, when the aggregated trajectory data reveals a frequently encountered sharp curve or a lane-merge region, the vehicle may temporarily increase camera frame rate, activate LIDAR more frequently, or extend RADAR sensing range to improve detection accuracy in those areas. Conversely, when aggregated data indicates stable straight-road segments consistently reported by many vehicles, certain sensors may reduce sampling frequency or enter a low-power mode to save energy while maintaining safety.

An autonomous driving level and/or autonomous driving activation/deactivation may also be controlled based on the feature of generating road map information by aggregating trajectory data obtained from multiple vehicles. For example, when newly aggregated multi-vehicle trajectory data indicates a previously unseen curve, a narrowed lane, or an upcoming U-turn zone, the autonomous driving level may be elevated to require increased user attentiveness (e.g., prompting the driver to hold the steering wheel or look ahead more frequently). Conversely, when the aggregated trajectory data confirms stable lane geometry or consistent driving directions across many vehicles, the autonomous driving system may activate a higher automation level or extend autonomous operation duration.

According to the present disclosure, a method and apparatus are provided for generating detailed road map information that may support safe and accurate vehicle driving. The method uses driving data collected from many vehicles, including information about where the vehicles traveled and the directions in which they moved. Based on this data, representative points along each route are selected, and similar points are grouped together into clusters. The relationships between the clusters are analyzed to determine how road sections are connected or separated, such as whether lanes merge, split, or form intersections. From these relationships, the system generates segments of the road, identifies driving directions, and detects special areas such as U-turn zones and intersections. The generated information is then used to create high-definition road maps, which may be provided to vehicles so that they may plan and control their driving more accurately. In simple terms, the present disclosure enables cars to share what they “see” on the road, allowing the entire network to build smarter, more detailed maps that support safer and more reliable driving.

Hereinafter, examples of the present disclosure will be described with reference to the accompanying drawings.

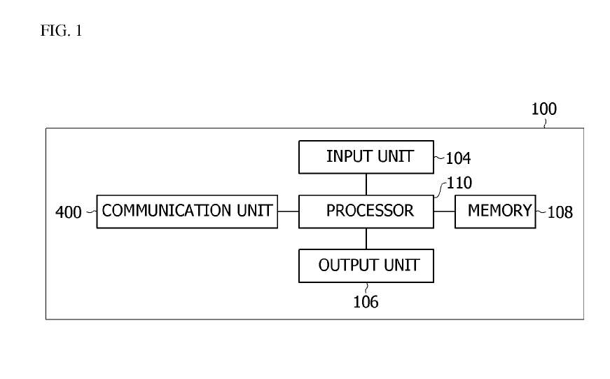

An apparatus for generating road map information will now be described with reference to FIG. 1, in accordance with an example of the present disclosure. FIG. 1 shows an example of modules constituting the apparatus for generating the road map information according to one example of the present disclosure.

Referring to FIG. 1, the apparatus 100 (e.g., a server) for generating the road map information may be an apparatus that generates road information based on route data of a route on which a plurality of vehicles have driven and sensor data of surrounding environments acquired from sensors of the plurality of vehicles, and generates the road map information based on the road information. In addition, the apparatus 100 (e.g., a server) for generating the road map information may transmit the road map information to a vehicle 200. Hereinafter, for ease of description, the apparatus 100 (e.g., a server) for generating the road map information may be referred to simply as a generating apparatus 100 (e.g., a server).

The road map information may be, for example, a high-definition map (HD map) at a lane level. The road information may include, for example, but is not limited to, lanes, driving directions for each of the lanes, U-turn zones, intersection zones, or the like, and may include data indicating various road conditions and states (e.g., lane boundaries, road curvature, road-grade changes, or traffic-control objects, etc.).

The generating apparatus 100 (e.g., a server) may be an electronic apparatus or a computing apparatus that receives the route data and the sensor data of a plurality of vehicles from the plurality of vehicles or an external device, and generates the road map information. The sensor data may include image data of the surrounding environment obtained from multiple cameras of the vehicle 200, or data of a sensor that provides point cloud data that detects the surrounding environment, such as lidar data or radar data (e.g., front-camera images, 360-degree surround-view images, lidar point clouds, or radar reflections, etc.).

Meanwhile, the vehicle 200 that receives the road map information from the generating apparatus 100 (e.g., a server) may refer to a movable device. The vehicle 200 is a land vehicle that drives on the land, and may be a conventional passenger or commercial vehicle, a Purpose-Built Vehicle (PBV), or the like (e.g., taxis, shuttles, delivery vans, or industrial mobility platforms, etc.). The vehicle 200 may be considered a robot in a broad sense, such as a means of mobility, and the robot may be moved using wheels, tracks, or other types of mobility modules (e.g., articulated wheel sets, tracked modules, or omni-directional wheel units, etc.). The vehicle 200 may be driven autonomously or manually.

The vehicle 200 that is autonomously driven may be implemented as semi-autonomous driving or fully autonomous driving. Fully autonomous driving may be provided as autonomous mobility in which the vehicle 200 has full control without user intervention, even if a driving situation is uncertain. Semi-autonomous driving may be provided as autonomous mobility that requires driver intervention depending on specific driving situations (e.g., poor visibility, complex intersections, or emergency maneuvers, etc.). The vehicle 200 may generate route information of the vehicle or control an operation of the vehicle 200, for example, driving, based on the road map information.

The generating apparatus 100 (e.g., a server) may be, for example, a device separate from the vehicle 200, such as a server, which is operated by a vehicle manufacturer or operated by a management agency that provides map information or autonomous driving services. The server (see 200 in FIG. 12) may not only provide road map information but also transmit an application or a learning model for autonomous driving to the vehicle. If the server 100 is operated by the vehicle manufacturer or the management agency that supports autonomous driving, the server 100 may receive connected data of the vehicle 200 or transmit data necessary for autonomous driving (e.g., perception models, localization parameters, or vehicle-to-cloud updates, etc.). In order to support autonomous driving and various services of the vehicle 200, the server 100 may transmit various information and software modules used for controlling the vehicle 200 to the vehicle 200 in response to a request and data transmitted from the vehicle 200 and a user device. In the present disclosure, a calibration function of a camera among various functions of the server 100 will be mainly described.

The generating apparatus 100 (e.g., a server) may include a communication unit 102, an input unit 104, an output unit 106, a memory 108, and a processor 110.

The communication unit 102 may support mutual communication with an external device, vehicles 100, 400, or the like. In the present disclosure, the communication unit 102 may be a communication interface that receives the route data, and the sensor data received from the external device or the vehicles 100, 400. The communication interface may transmit the road map information generated based on the route data to the vehicles 100, 400 (e.g., via LTE, 5G, V2X, or Wi-Fi links, etc.).

The input unit 104 may include an interface for receiving a request from a user, and the output unit 106 may include an interface that visually provides information generated according to the present disclosure. The information may include, for example, the road information or the road map information generated based on route data, road map information corrected by sensor data, and intermediate data output in a process of generating the road map information (e.g., clustering results, segment boundaries, or heading-angle plots, etc.).

The memory 108 may store a program and various data for controlling the generating apparatus 100 (e.g., a server), so as to load the program or read and write data upon request of the processor 110.

In the present disclosure, the memory 108 may hold an application for generating the road map information according to the present disclosure and store the generated road map information and related data (e.g., historical map tiles, processed trajectory data, or cluster-level metadata, etc.).

The processor 110 may perform overall control of the generating apparatus 100 (e.g., a server). The processor 110 may be configured to execute the application and instructions stored in the memory 108. Specifically, the processor 110 may execute a process of generating clusters by performing clustering of representative points based on heading data of a representative region having a representative point selected from trajectory data of a plurality of vehicles. In addition, the processor 110 may execute a process of generating connectivity information of the clusters indicating connection or separation between the clusters based on the heading data of the representative points in the clusters. The processor 110 may execute a process of generating a segment by grouping the clusters based on the connectivity information. In addition to this, the processor 110 may perform a process of generating road information of a road corresponding to the segment based on the connectivity information of the clusters in the segment. The processor 110 may implement a process of generating the road map information based on the road information and transmitting the road map information to the vehicle 200 (e.g., for localization, path planning, or predictive driving, etc.). Details of the above-described processes by the processor 110 will be described later.

In the present disclosure, the processor 110 may be implemented as a single processing module as an example. As another example, the processes above-mentioned may be distributed across a plurality of processing modules, and the processor 110 may also be collectively referred to as a plurality of processing modules in the present disclosure.

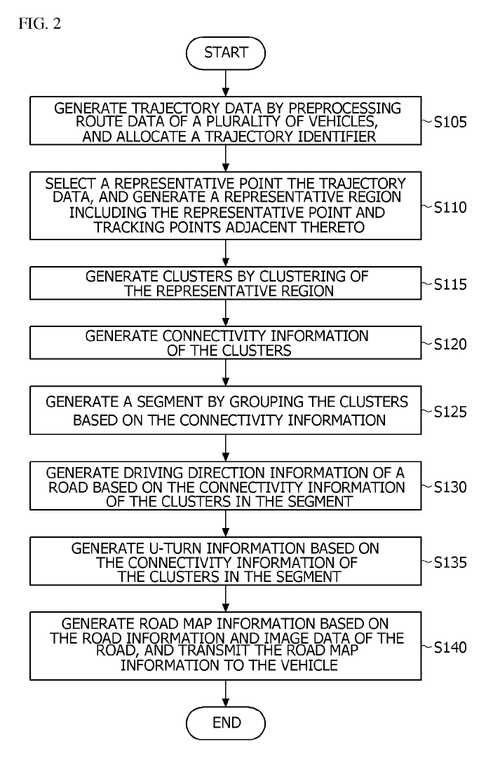

A method for generating road map information will now be described with reference to FIGS. 2-8, in accordance with another example of the present disclosure. FIG. 2 shows an example of a method of generating the road map information according to another example of the disclosure. Hereinafter, the method is mainly performed by the processor 110 of the generating apparatus 100 (e.g., a server), but the processor 110 of the generating apparatus may be referred to simply as the generating apparatus 100 (e.g., a server) for ease of description, or these terms may be used interchangeably.

Referring to S105 of FIG. 2, the processor 110 of the generation device 100 may generate the trajectory data by preprocessing the route data received by the plurality of vehicles 100, 400 or an external device, and allocate a trajectory identifier to each trajectory data.

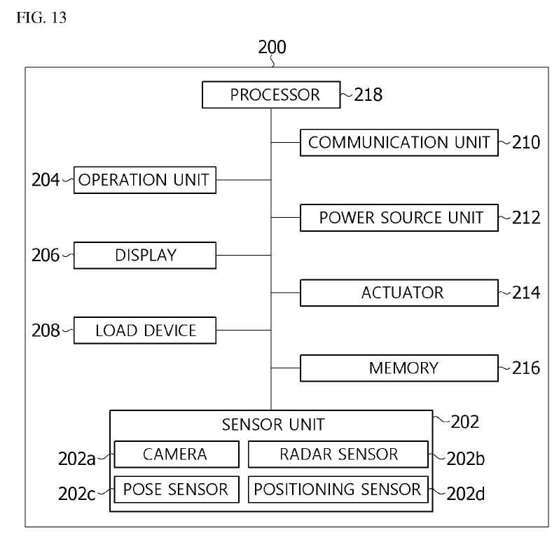

The route data may include position data and heading data according to a driving trajectory of the vehicles 100, 400 (hereinafter, denoted by 100 for ease of description). The position data may include, for example, GPS data obtained from a positioning sensor 202d (of FIG. 13) of the vehicle 200 (e.g., latitude, longitude, altitude, or GNSS accuracy indicators, etc.). The heading data may include, for example, an heading angle estimated based on the GPS data or data of a pose sensor 202c (of FIG. 13) of the vehicle 200 (e.g., IMU-based yaw rate, gyroscope outputs, or wheel-odometry direction estimates, etc.). The route data may be provided for each vehicle 200. In addition, the route data may be provided as a time-series plurality of points generated according to an acquisition cycle of the positioning sensor 202d, and may include points tracked for each vehicle, for example.

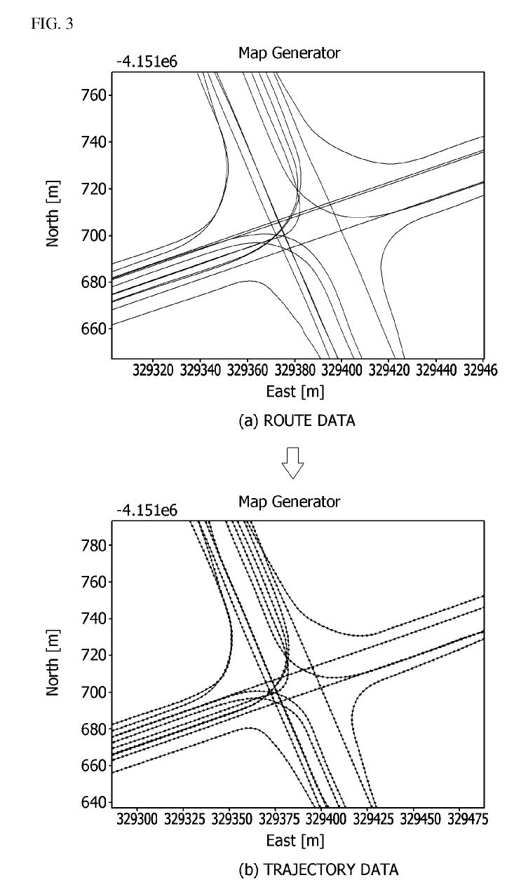

As illustrated in FIG. 3, the preprocessing may sample points at a predetermined distance interval from the route data having points arranged in time series as tracking points and generate the trajectory data based on the sampled tracking points. The predetermined distance may be, for example, 0.5 to 1.5 m (e.g., 0.5 m, 1.0 m, or 1.5 m, etc.). FIG. 3 shows an example of generation of the trajectory data by the preprocessing of the route data. The trajectory data is generated to have the tracking points for each vehicle 200, for example, and the processor 110 may allocate a trajectory identifier to each trajectory data.

Referring to S110 of FIG. 2, the processor 110 may select a representative point from tracking points of the trajectory data and generate a representative region including the representative point and tracking points adjacent thereto.

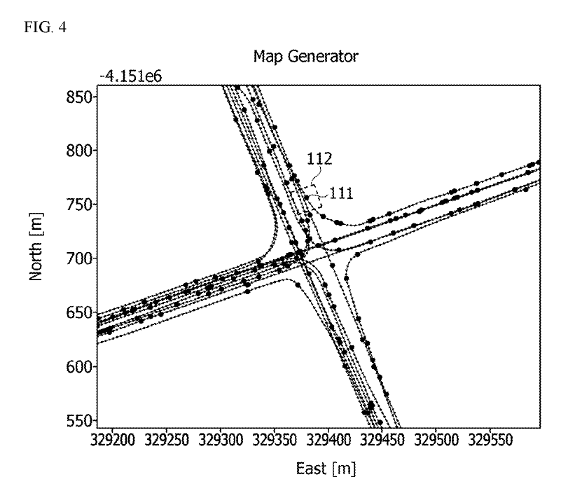

As illustrated in FIG. 4, the processor 110 may randomly select tracking points of the trajectory data at regular intervals, adopt the selected points as representative points 111, and form a representative region 112 having the representative points 111 and tracking points adjacent thereto. FIG. 4 shows an example of selection of a representative point in the trajectory data. That is, the representative points 111 may be tracking points belonging to a representative region that clusters tracking points arranged in the trajectory data at a predetermined interval (e.g., 1 m, 2 m, or 5 m spacing, etc.).

The processor 110 may generate region information such that each representative region 112 has region information associated with tracking points within the region. The region information may include, for example, position data of the tracking points, heading data of the tracking points, a center position of the representative region, and average heading data according to an average of the heading data. The average heading data may include, for example, an average heading angle according to an average of the heading angles of the tracking data of the representative region (e.g., mean yaw angle, median direction, or a filtered heading estimate, etc.).

Referring to S115 of FIG. 2, the processor 110 may generate clusters by performing clustering of the representative points 111 based on the heading data of the representative region 112.

Specifically, the processor 110 may identify a center position for each representative region 112 and identify a tracking point that intersects a virtual line that is perpendicular to an average heading angle of the average heading data in the representative region 112.

Taking the identification of the tracking point as an example, the processor 110 may select, from among the tracking points intersecting the virtual line, a tracking point in which a distance between the closest points in the adjacent representative regions 112 is arranged to be less than or equal to a threshold distance. The threshold distance may be, for example, 25 to 35 m (e.g., 25 m, 30 m, or 35 m, etc.). In addition, the processor 110 may select from among the tracking points intersected the virtual line, a tracking point in which a difference in an average directing angle between the adjacent representative regions 112 is arranged to be less than or equal to a threshold angle. The threshold angle may be, for example, 25 to 35 degrees (e.g., 25°, 30°, or 35°, etc.). In addition to this, the processor 110 may select the tracking point that is arranged in opposite directions from each other in average directing data between adjacent representative regions. The difference in average directing angle along the opposite directions may be, for example, 170 to 190 degrees (e.g., 170°, 180°, or 190°, etc.).

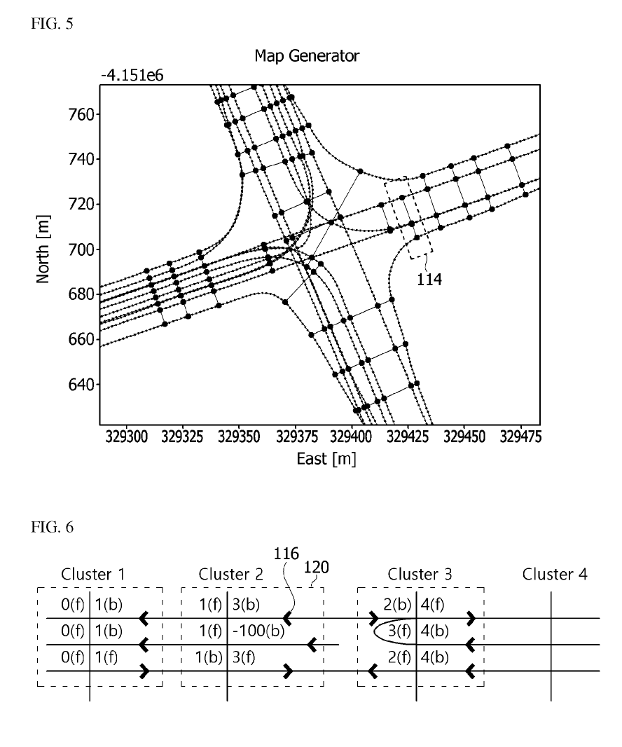

As illustrated in FIG. 5, the processor 110 may generate clusters 114 by grouping the representative regions 112 including the selected tracking points. FIG. 5 shows an example of a cluster. In FIG. 5, a line interconnecting the representative points 110 is depicted as the cluster 114. The processor 110 may generate, for each of clusters 114, clusters information including a cluster identifier and region information of the representative region 112. The region information has been described in S110, and a detailed description thereof will be omitted. The above-described generation process of the clusters 114 may be repeatedly performed until the center position and the average heading data of the representative region are converged (e.g., changes below a preset threshold, stabilized averages, or minimal drift in heading, etc.).

Referring to S120 of FIG. 2, the processor 110 may generate, based on the heading data of the representative points 111 in the clusters 114, connectivity information of the clusters indicating connection or separation between the clusters.

As illustrated in FIG. 6, the processor 110 may identify, for each of the representative points 111 of the clusters 114, forward clusters in heading directions of the heading data at the representative points 111 and backward clusters in directions different from the heading directions of the representative points 111 (e.g., forward-moving clusters, reverse-direction clusters, or diverging-path clusters, etc.). The forward clusters and the backward clusters may be recorded in the connectivity information with any one of identifiers of adjacent clusters neighboring the representative points 111, identifiers of clusters in which the representative points 111 are included, or disconnection identifiers.

FIG. 6 shows an example of connectivity information. Taking Cluster 2 of FIG. 6 as an example, Cluster 2 is illustrated as including three representative points, the top two representative points having leftward directions 116, and the bottom one representative point having a rightward direction (e.g., left-turn flow, lane-merge flow, or diverging-lane flow, etc.). The forward and reverse directions are denoted as f and b, respectively, in FIG. 6.

For the representative points of Cluster 2 positioned at the top, the processor 110 may identify Cluster 1 preceding it in the leftward direction as the forward cluster and identify Cluster 3 following it in the leftward direction as the backward cluster. For the representative points positioned at the top, the forward cluster may be recorded with the identifier of Cluster 1 adjacent to Cluster 2, and the backward cluster may be recorded with the identifier of Cluster 3 adjacent to Cluster 2.

For the representative points of Cluster 2 positioned in the middle, the processor 110 may identify Cluster 1 preceding it in the leftward direction as the forward cluster and identify the following point in the leftward direction as not belonging to any cluster. Not belonging to any cluster may mean that there is no representative point (or representative region) connected to the representative points (or the representative regions) of Cluster 2 positioned in the middle, and thus there is no cluster adjacent to the representative points of Cluster 2 positioned in the middle (e.g., isolated point, outlier region, or dead-end tracking point, etc.). For the representative points positioned in the middle, the forward cluster may be recorded with the identifier of Cluster 1 adjacent to Cluster 2, and the backward cluster may be recorded with the disconnection identifier. In FIG. 6, the disconnection identifier is illustrated as −100 (e.g., −1, −50, or −100 as special separation codes, etc.).

For the representative points of Cluster 2 positioned at the bottom, the processor 110 may identify Cluster 3 preceding it in the rightward direction as the forward cluster and identify Cluster 1 following it in the rightward direction as the backward cluster. For the representative points positioned at the bottom, the forward cluster may be recorded with the identifier of Cluster 3 adjacent to Cluster 2, and the backward cluster may be recorded with the identifier of Cluster 1 adjacent to Cluster 2.

In addition, the forward clusters and the backward clusters of the representative points in Cluster 3 may be identified to be substantially the same as Cluster 2. However, for the representative points of Cluster 3 positioned in the middle, the processor 110 may identify the preceding point in the leftward direction as Cluster 3 itself. That is, the preceding point may be identified by an identifier of Cluster 3 to which representative points positioned in the middle belong. The identifier of the cluster itself may mean that the representative point in the cluster is connected to another representative point of the cluster itself (e.g., same-lane continuity, U-turn loops, or circular-road movement, etc.). According to the example of FIG. 6, the representative point in Cluster 3 positioned in the middle is connected to the representative point of Cluster 3 positioned at the top, so that the forward clusters of the representative points positioned in the middle may be identified as Cluster 3.

The processor 110 may generate, based on at least some of the forward clusters and the backward clusters associated with representative points belonging to each of neighboring clusters being identified as the neighboring clusters (e.g., matching directions, aligned trajectories, or consistent regional headings, etc.), the connectivity information indicating a connection between the clusters. In addition, the processor 110 may be configured to generate, based on all of the forward clusters and the backward clusters associated with representative points belonging to each of neighboring clusters not being identified as the neighboring clusters (e.g., direction mismatches, disconnected regions, or abrupt directional changes, etc.), the connectivity information indicating separation between the clusters.

According to the example of FIG. 6, the backward cluster of the representative points in Cluster 2 positioned in the middle is recorded with the disconnect identifier. However, the forward clusters and the backward clusters of each of the top representative point and the bottom representative point in Cluster 2 are recorded with the identifier of adjacent Cluster 1 and the identifier of adjacent Cluster 3. The processor 110 may generate, based on at least some of the forward clusters being identified as a neighboring cluster, connectivity information indicating a connection between Cluster 2 and Cluster 1 (e.g., forward-direction continuity, lane-following behavior, or consistent turning flow, etc.). In addition, the processor 110 may generate, based on at least some of the backward clusters being identified as a neighboring cluster, connectivity information indicating a connection between Cluster 2 and Cluster 3 (e.g., shared downstream heading, merging-lane continuation, or opposite-lane transitions, etc.).

To describe the connectivity information related to the separation, if at least one of the forward clusters of representative points in Cluster 2 is identified as an adjacent cluster, i.e., Cluster 1, the processor 110 may generate the connectivity information indicating the connection between Cluster 2 and Cluster 1. However, if all of the backward clusters of representative points in Cluster 2 are not identified as Cluster 3, but are identified by the disconnection identifier and as Cluster 2 to which the representative points belong, the processor 110 may generate the connectivity information indicating separation between Cluster 2 and Cluster 3 (e.g., lane divergence, direction mismatch, or opposite-heading patterns, etc.).

According to the above, the connectivity information 120 includes data indicating connection or separation between clusters in generation, but the processor 110 may generate the connectivity information 120 to further include forward clusters, backward clusters, and heading directions 116 for each of the representative points belonging to the clusters illustrated in FIG. 6 in addition to the data (e.g., per-cluster direction sets, node-to-node graph links, or representative-point direction tags, etc.).

Referring to S125 of FIG. 2, the processor 110 may generate the segment by grouping the clusters 114 based on the connectivity information.

As illustrated in FIG. 7, the processor 110 may generate the segment 124 by merging the clusters 114, based on the connectivity information indicating the connection (e.g., continuous heading flow, lane-following relations, or stable directional patterns, etc.). FIG. 7 shows an example of a segment. In addition to this, the processor 110 may remove a cluster that does not have a relationship of connection (e.g., isolated clusters, noise clusters, or direction-inconsistent clusters, etc.).

Referring to S130 of FIG. 2, the processor 110 may generate driving direction information of a road corresponding to the segment 124 based on the connectivity information of the clusters in the segment 124.

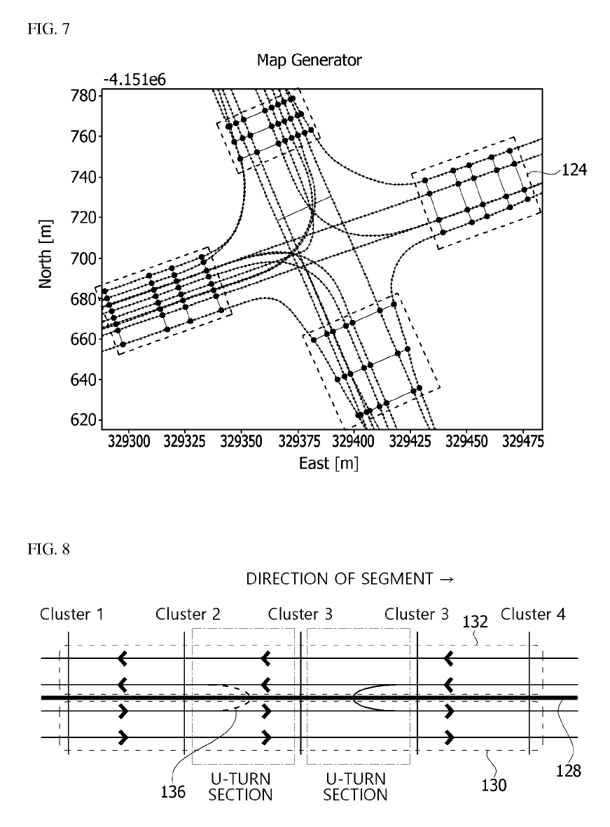

As illustrated in FIG. 8, the processor 110 may generate a center line 128 passing through the centers of the clusters in the segment 124 to be parallel to a direction of the segment set in a predetermined manner (e.g., average heading, dominant flow, or predefined segment axis, etc.). The center line 128 may be estimated as a centerline of a road. FIG. 8 shows an example of generation of road information.

The processor 110 may generate, based on the connectivity information of the clusters, the driving directions of the representative points arranged on both sides of the center line 128. The processor 110 may generate, based on the forward clusters and the backward clusters for each of the representative points in the clusters, driving directions of the representative points on the both sides (e.g., opposite-direction lanes, bidirectional flows, or reversible-lane patterns, etc.). As in the example of FIG. 8, the representative points on both sides may be allocated to and divided into a first driving direction section 130 and a second driving direction section 132, respectively. In FIG. 8, it may be provided that the first driving direction section 130 and the second driving direction section 132 have a driving direction same as the direction of the segment and a driving direction opposite to the direction of the segment, respectively. The first driving direction section 130 and the second driving direction section 132 may also be referred to as a road belt in the first driving direction and a road belt in the second driving direction, in the present disclosure.

The processor 110 may generate driving direction information of the road estimated as the first and second driving direction sections 130 and 132 based on the driving direction (e.g., leftward flows, rightward flows, or alternating traffic patterns, etc.).

Referring to S135 of FIG. 2, the processor 110 may generate U-turn information of a road corresponding to the segment 124 based on the connectivity information of the clusters in the segment 124.

As illustrated in FIG. 8, the processor 110 may generate the U-turn information in which a U-turn section in the lane associated with the representative points positioned in the middle is estimated, based on the connectivity information in which the forward clusters of the representative points in Cluster 2 positioned in the middle and the forward clusters of the representative points in Cluster 4 positioned in the middle are each identified as its own cluster (e.g., self-loop patterns, sharp heading reversals, or 180-degree directional changes, etc.).

Referring to S140 of FIG. 2, the processor 110 of the generating apparatus 100 (e.g., a server) may generate road map information based on the road information including the driving direction information and the U-turn information, and transmit the road map information to the vehicle 200. Additionally, the processor 110 may generate or update the road map information based on the road information and data of a sensor that detects the surrounding environment (e.g., camera updates, lidar corrections, or radar-based refinements, etc.).

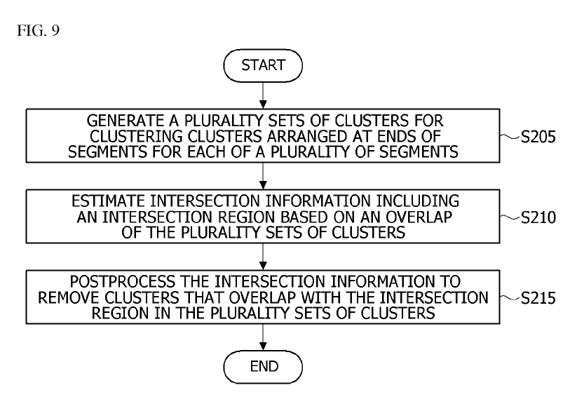

A process of generating intersection information included in road information will now be described with reference to FIGS. 9 - 11. FIG. 9 shows an example of a method of generating the road map information according to another example of the disclosure.

The generation of the intersection information may be performed after performing the same process as S105 to S125 in FIG. 2. The intersection information may be generated by using the clusters and the segments (e.g., multi-lane convergence, lane splits, or multi-approach road crossings, etc.).

Referring to S205 of FIG. 9, following S125, the processor 110 may generate a plurality of sets of clusters for clustering the clusters arranged at the ends of the segments for each of a plurality of segments.

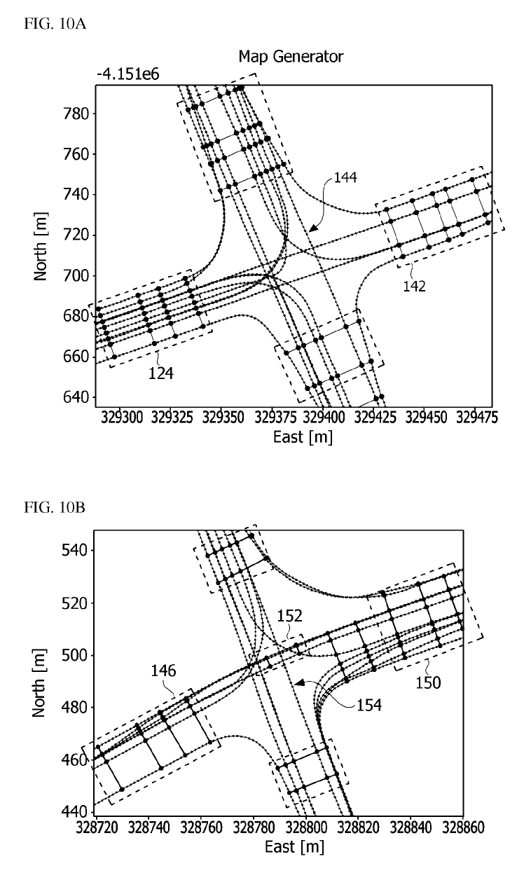

The plurality sets of clusters may not be clusters configured in a same segment based on route data of a same vehicle group on a same road, but may be clusters configured in different segments based on the route data of different vehicle groups on the same road (e.g., morning vs. evening traffic groups, different vehicle fleets, or varied sampling intervals, etc.). As illustrated in FIGS. 10A and 10B, even if the segments 124, 142 in FIG. 10A and the segments 146, 150, and 152 in FIG. 10B are in the same road section, they may have different segment identifiers. FIGS. 10A and 10B are diagrams illustrating estimation of intersection information.

This may be attributed to the fact that the generation of segments of mutually different groups of vehicles is processed separately (e.g., per-fleet generation, per-direction estimation, or per-time-window segmentation, etc.).

According to the example of FIG. 10A, the processor 110 may generate a set of clusters clustering clusters arranged at ends of the segments 124, 142 for each of the plurality of segments 124, 142. The clusters at the ends may be clusters identified based on the connectivity information in which one side is separated in FIG. 10A and may be clusters located at both ends of the segments 124 and 142 (e.g., terminal nodes, approach clusters, or diverging end clusters, etc.). The sets of clusters in FIG. 10A may include clusters at ends of four segments adjacent to a reference numeral 144.

According to the example of FIG. 10B, the processor 110 may generate a set of clusters clustering clusters arranged at ends of the segments 146, 150, 152 for each of the plurality of segments 146, 150. The clusters set in FIG. 10B may include clusters at the ends of five segments adjacent to a reference numeral 154.

Referring to S210 of FIG. 9, the processor 110 may estimate intersection information including an intersection region based on an overlap of the plurality sets of clusters. The processor 110 may determine an overlap region by overlapping the sets of clusters illustrated in FIGS. 10A and 10B and estimate the intersection regions 144 and 154 based on the overlap region (e.g., shared-node areas, multi-approach convergence zones, or segment crosspoints, etc.).

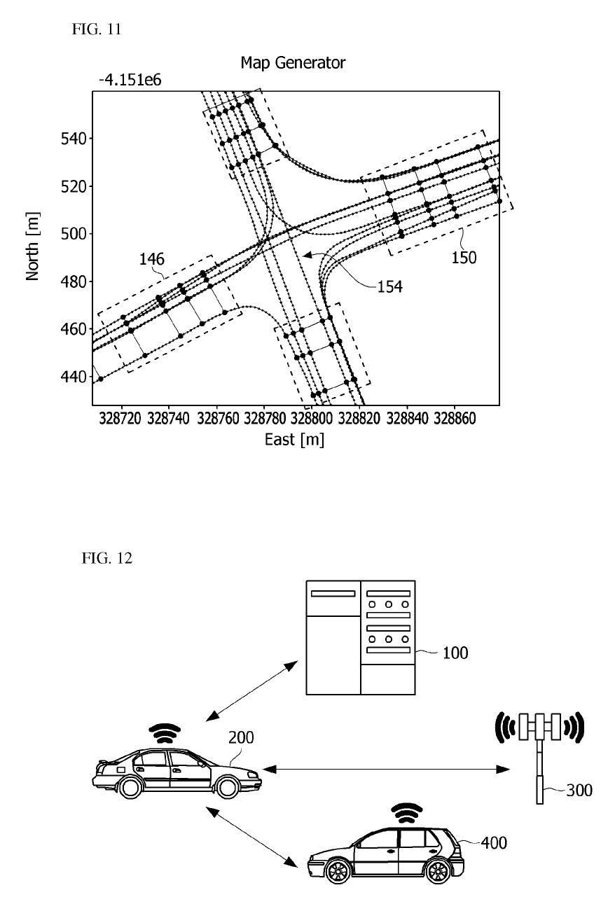

Referring to S215 of FIG. 9, the processor 110 may postprocess the intersection information to remove clusters that overlap with the intersection region in the plurality sets of clusters. FIG. 11 shows an example of postprocessing of intersection information. As illustrated in FIG. 11, the processor 110, through postprocessing, may remove the cluster 152 that overlaps with the intersection region 154 estimated in FIG. 10B, and maintain the clusters associated with the four segments 146 and 150 (e.g., keeping valid lane approaches, removing duplicated clusters, or pruning redundant path entries, etc.).

The processor 110 may proceed to step S140 and generate road map information based on the road information including the intersection information, the driving direction information, and the U-turn information. In addition, the processor 110 may transmit the road map information to the vehicle 200.

According to the present disclosure, it is possible to provide a method and apparatus that accurately generate various types of road information based on route data to support vehicle driving.

The vehicle 200 that receives the road map information generated in FIG. 2 and another device that communicates with the server 100 will be described.

FIG. 12 shows an example that a vehicle communicates with another device to transmit and receive data.

The vehicle 200 may refer to a device that may move to a specific point, as described above. Although the present disclosure describes the vehicle 200 as a vehicle driving on the land as an example, the present disclosure may also be applied to a mobility apparatus for flight or water transportation (e.g., drones, unmanned boats, or air taxis, etc.). The vehicle 200 may be controlled to drive by autonomous driving, as described above in FIG. 1, and the autonomous driving may be implemented as semi-autonomous driving or fully autonomous driving.

The vehicle 200 may be powered by electric energy or fossil energy. For the electric energy, the vehicle 200 may employ, for example, a pure battery-based vehicle driven only by a high-voltage battery or a gas-based fuel cell as an energy source (e.g., hydrogen fuel cell, LNG-based fuel cell, or ammonia-based fuel cell, etc.). In addition, the fuel cell may utilize various types of gas capable of generating electric energy, and the gas may be hydrogen as an example. However, the present disclosure is not limited thereto, and various gases may be applicable. For the fossil energy, the vehicle 200 is driven based on a fuel such as gasoline, diesel, or liquefied gas, and may be equipped with an engine that drives a wheel included in the actuator 214 by combustion of the fuel. The engine may be included in the power source unit 212 from the viewpoint of providing a driving rotational force of the wheel to the actuator 214. As another example, the vehicle 200 may also be driven in a hybrid manner of electric energy and fossil energy (e.g., plug-in hybrids, mild hybrids, or series hybrids, etc.).

The vehicle 200 may perform communication with the other devices 200, 300 or the other vehicle 400. The other devices may include, for example, the generating apparatus 100 (e.g., a server) that supports various controls, state management, and driving of the vehicle 200, and ITS device 300 for receiving information from an ITS, various types of user devices, or the like (e.g., smartphones, tablets, or wearable devices, etc.). The generating apparatus 100 (e.g., a server) may be, for example, an external device operated by a vehicle manufacturer or operated by a management agency that services autonomous driving, as described above in FIG. 1.

The ITS device 300 is, for example, a Road Side Unit (RSU), and the ITS device 300 may interchange vehicle recognition data, driving control and state data, environmental data around the vehicle, map data, or the like through V2I with the vehicle 200 to assist the user in driving the own vehicle or support autonomous driving of the vehicle 200 (e.g., traffic-signal timing, pedestrian warnings, or accident alerts, etc.). The vehicle 200 may interchange the above-listed data through V2V with the other vehicle 400 to support driving of the own vehicle or autonomous driving.

Vehicle 200 may communicate with other vehicles 400 or other devices 200 and 300 based on Cellular communication, Wireless Access in Vehicular Environment (WAVE) communication, Dedicated Short Range Communication (DSRC) or near field communication, or other communication schemes (e.g., Bluetooth LE, UWB, or Wi-Fi Direct, etc.).

For example, for the vehicle 200 to communicate with the server 100, the ITS device 300, and the other vehicle 400, a communication network such as LTE or 5G, a WiFi communication network, a WAVE communication network, or the like may be used as a cellular communication network (e.g., LTE-V2X, 5G NR-V2X, or IEEE 802.11p, etc.). For another example, a DSRC or the like used in the vehicle 200 may also be used for communication between vehicles. A communication manner between the vehicle 200, the server 100, the ITS device 300 and the other vehicle 400, and a user device is not limited to the foregoing examples.

FIG. 13 shows an example of a module constituting a vehicle according to the present disclosure.

The vehicle 200 may include a sensor unit 202, an operation unit 204, a display 206, a load device 208, and a communication unit 210.

The sensor unit 202 may include various types of sensors for sensing various states and situations occurring in an external surrounding environment, an internal system, a user operation, and a boarding space of the vehicle 200 (e.g., environmental sensors, cabin sensors, or driver-monitoring sensors, etc.).

Specifically, the sensor unit 202 may include an externally oriented image sensor (e.g., camera 202a), a radar sensor 202b, or the like so as to recognize dynamic and static objects existing around the vehicle 200.

The camera 202a may generate image data by recognizing an external object as an image during use of the vehicle 200 and transmit the image data to the processor 218. The camera 102a may be mounted on a specific site of the vehicle 200, for example, a front site, a rear site, or side sites of the vehicle 200. If a plurality of image sensors 202a are mounted on each site, it may be referred to as a multi-camera in the present disclosure. The image data obtained by the plurality of image sensors (e.g., multiple cameras 102a) may be referred to as a multi-view image data or a multi-view (e.g., surround-view stitched images, 360-degree fisheye views, or panoramic views, etc.).

The radar sensor 202b may generate radar data through radio waves reflected from an external object by emitting radio waves of specific frequencies around the vehicle 200 in order to get the presence, relative distance, speed, direction, or the like of the external object (e.g., vehicles, pedestrians, bicycles, or static obstacles, etc.). Although an example in which a lidar sensor (not shown) is not mounted is illustrated in the present disclosure, in another example, the lidar sensor may be mounted on the vehicle 200.

The sensor unit 202 may include a pose sensor 202c. The pose sensor 202c may detect, for example, states for each of three axes of the vehicle 200, such as yaw, pitch, and roll, and output various pose states of the vehicle based on the above-described factors. The pose sensor may include, for example, an IMU sensor, a gyro sensor, or the like (e.g., 6-axis IMU, 9-axis IMU, or MEMS-based gyroscope, etc.). The processor 218 may generate pose data based on the pose state.

In addition, the sensor unit 202 may include a positioning sensor 202d for confirming the position of the vehicle 200. The positioning sensor 201d is, for example, but not limited to, a GPS sensor or a GNSS sensor (e.g., GLONASS, Galileo, or BeiDou receivers, etc.).

The present disclosure mainly describes the sensors of the sensor unit 202 referred to in the description and may further include sensors that sense various situations not listed therein (e.g., temperature sensors, rain sensors, or cabin-occupancy sensors, etc.).

The operation unit 204 may be configured as a module for a user to steer for driving. For example, the operation unit 204 may be a steering wheel for manual driving, an automatic or manual transmission actuator, an accelerator pedal, a brake pedal, a gear transmission, or the like (e.g., shift-by-wire modules, electronic brake pedals, or steer-by-wire interfaces, etc.). The operation unit 204 may further include an interface for using, releasing, and selecting a detailed function of an autonomous driving mode requested by the user, so that the user uses the autonomous driving function.

The display 206 may function as a user interface. The display 206 may be displayed by the processor 218 to output an operation state of the vehicle 200, a control state, route/traffic information, remaining energy information, content requested by the driver, or the like. In addition, the display 206 may be configured as a touch screen capable of detecting a driver input, to receive a request from the driver instructing the processor 218 (e.g., selecting routes, approving lane changes, or adjusting ADAS settings, etc.).

The load device 208 is mounted on the vehicle 200 and may be a type of non-driving electric device excluding a driving power system such as a wheel driving unit (not shown). The load device 208 is an auxiliary device that receives power from the power source unit 212, and may be, for example, an air conditioning system, an indicator lamp system, a lighting system, a seat system, and various apparatus installed in the vehicle 200 (e.g., infotainment modules, HVAC units, or door-control modules, etc.).

The communication unit 210 may support mutual communication with the server 100, the ITS device 300, the surrounding vehicle 400, or the like. The communication unit 210 may include, for example, a module that processes cellular communication, WAVE, DSRC communication, or the like (e.g., LTE-V2X modem, 5G modem, or DSRC transceiver, etc.). In the present disclosure, the communication unit 210 may transmit data generated or stored during driving to the server 100 and receive data and a software module transmitted from the server 100. The communication unit 210 may support communication for transmitting or receiving signals related to data, control, commands, and requests between the components in FIG. 13. The components may be instruments or modules referred to as reference numerals 202 to 218 illustrated in FIG. 13, for example. The communication unit 110 may transmit signals transmitted between the components, that is, signals related to the data, the control, the commands, and the requests, to a communication bus by using CAN (Controller Area Network) communication, for example, and transmit the signals to a specific component (e.g., engine ECU, brake ECU, or body-control module, etc.). The data, control, the commands, and the requests transmitted in the CAN communication may be referred to as CAN data. The communication unit 210 may also support communication with an electronic device carried by an occupant inside the vehicle 200 (e.g., smartphone pairing, wireless charging, or media-control interfaces, etc.).

The vehicle 200 may also include a power source unit 212 and an actuator 214.

The power source unit 212 may generate and supply power and electric power to be used for a driving power system and a non-driving power system, such as the actuator 214 (e.g., supplying traction power, HVAC power, or sensor-system power, etc.). The non-driving power system may be, for example, the sensor unit 202, the operation unit 204, the display 206, the load device 208, the communication unit 210, and the like, and may include, but not limited thereto, various components implementing sensing, interfacing, communicating, and convenience functions except for components directly involved in a driving operation.

The actuator 214 includes at least one module that implements a driving operation and may execute the driving operation based on a user request from the operation unit 204 or a signal according to a request of the processor 218. The signal according to the request may be related to, for example, at least one of a longitudinal control such as acceleration and deceleration, a lateral control such as steering, and a gear shift (e.g., throttle-by-wire, brake-by-wire, or shift-by-wire signals, etc.). Here, the gear shift may be processed by a request of a manual driving of user using a gear transmission or the processor 218 in autonomous driving.

The actuator 214 may include a wheel driving unit (not shown), a mechanical component for implementing a driving operation on the wheel driving unit, and an electronic module to perform a driving operation according to a command of the processor 218 by a user's manual operation or autonomous driving. When the vehicle 200 is operated based on electric energy, it may also include an assembly for transmitting a requested driving operation to the wheel driving unit (e.g., inverter modules, motor controllers, or reduction gears, etc.). When the vehicle 200 is operated based on fossil energy, the actuator 214 may include a transmission and a gear module for transmitting power of an internal combustion engine.

The wheel driving unit may include a plurality of wheels, a driving force generation module for generating a driving force and applying or transmitting the driving force to the wheels, a braking module for decelerating driving of the wheels, a steering module for realizing lateral control of the wheels, or the like. When the vehicle 200 is driven based on electric energy, the driving force generation module may be configured as a motor assembly that generates a driving force based on electric power output from an electric battery. The braking module of the electric-based vehicle 200 may further have a regenerative braking function (e.g., energy-recapture braking, blended braking, or coasting-regen modes, etc.).

The vehicle 200 may also include a memory 216 and a processor 218.

The memory 216 may store an application and various data for controlling the vehicle 200, so as to load the application or read and write data upon request of the processor 218. In the present disclosure, the memory 216 may receive and manage road map information from the server 100 (e.g., local HD map tiles, navigation layers, or road-attribute data, etc.). In addition, the memory 216 may receive and manage information necessary for driving, such as traffic information, weather information, accident information, or the like (e.g., congestion reports, hazard alerts, or storm-impact data, etc.).

The processor 218 may perform overall control of the vehicle 200. The processor 218 may be configured to execute the application and instructions stored in the memory 216. The processor 218 may control drive based on the road map information and the surrounding environment perceived from the sensor unit 202 (e.g., lane-keeping, adaptive cruising, or intersection-handling, etc.).In the present disclosure, the processor 218 may be implemented as a single processing module as an example. As another example, the processes above-mentioned may be distributed across a plurality of processing modules, and the processor 218 may also be collectively referred to as a plurality of processing modules in the present disclosure.

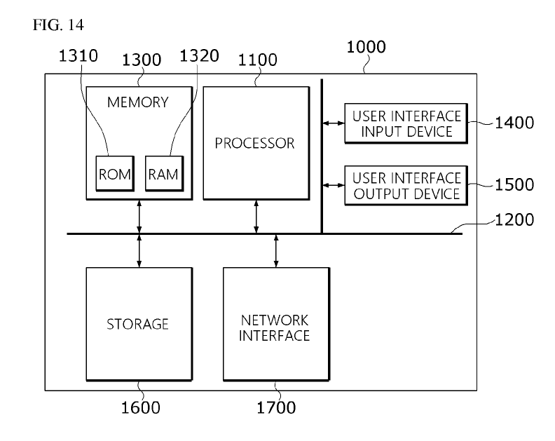

FIG. 14 shows an example computing system (e.g., a computing device of a vehicle or any other apparatus). One or more controllers, processors, etc. described herein, such as one or more components of the server 100, one or more components of the vehicle 200, one or more components of other vehicle 400, and any other components and devices disclosed herein, may be implemented by or in the computing system as shown in FIG. 14.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided a method for generating a road map information, the method comprising: generating clusters by performing clustering of representative points based on heading data of a representative region having a representative point selected from trajectory data of a plurality of vehicles; generating, based on the heading data of the representative point in the clusters, connectivity information of the clusters indicating connection or separation between the clusters; generating, based on the connectivity information, a segment by grouping the clusters; generating, based on the connectivity information of the clusters in the segment, road information including driving direction information of a road corresponding to the segment; and generating, based on the road information, road map information.

For examples, the representative point may be a tracking point belonging to the representative region that clusters tracking points arranged in the trajectory data at a predetermined interval. The generating clusters may comprise: identifying a central position for each representative region; generating average heading data of the tracking points, including an average heading angle for each representative region; identifying the tracking point intersecting a virtual line perpendicular to the average heading angle; and grouping representative regions including the identified tracking point to generate the clusters.

For examples, the identifying the tracking point may comprise identifying, among the tracking points intersecting with the virtual line, the tracking point at which a distance between closest points in adjacent representative regions is less than or equal to a threshold distance and a difference in an average directing angle between the adjacent representative regions is arranged less than or equal to a threshold angle.

For examples, the generating the connectivity information may comprise: identifying, for each of the representative points of the cluster, forward cluster in heading directions of the heading data at the representative points and backward cluster in directions different from the heading directions; generating, based on at least one of the forward cluster or the backward cluster associated with representative points belonging to each of neighboring clusters being identified as the neighboring clusters, the connectivity information indicating a connection between the clusters; and generating, based on at least one of the forward cluster or the backward cluster associated with representative points belonging to each of neighboring clusters not being identified as the neighboring clusters, the connectivity information indicating separation between the clusters; and the forward cluster and the backward cluster are recorded in the connectivity information with any one of identifier of adjacent cluster neighboring the representative point, identifier of cluster in which the representative point is included, or disconnection identifier.

For examples, the generating the segment may comprise generating the segment by grouping the clusters based on the connectivity information indicating the connection.

For examples, the generating road information including driving direction information of the road may comprises: generating a center line passing through centers of the clusters in the segment; generating driving directions of the representative points arranged on both sides of the center line based on the connectivity information of the cluster; and generating driving direction information of the road estimated to be the representative point based on the driving direction.

For examples, the road information may further comprise U-turn information. The method may further comprise generating, based on the connectivity information of the cluster in the segment, the U-turn information of the road corresponding to the segment.

For examples, wherein the road information may further comprise intersection information. The method may further comprise generating, based on a cluster arranged at an end of the segment, the intersection information.

For examples, the generating the intersection information may comprise generating, for each of a plurality of segments, a plurality sets of clusters clustering cluster arranged at ends of the segment; and estimating the intersection information including an intersection region based on an overlap of the plurality sets of clusters.

For examples, the generating the intersection information may further comprise postprocessing the intersection information to remove cluster that overlaps the intersection region in the plurality sets of clusters.

According to another example of the present disclosure, there is provided an apparatus for generating road map information, the apparatus comprising: a memory storing at least one instruction; and at least one processor to execute the at least one instruction stored in the memory. The at least one processor is configured to: generate clusters by performing clustering of representative points based on heading data of a representative region having a representative point selected from a plurality of trajectory data; generate, based on the heading data of the representative point in the clusters, connectivity information of the clusters indicating connection or separation between the clusters; generate, based on the connectivity information, a segment by grouping the clusters; generate, based on the connectivity information of the clusters in the segment, road information including driving direction information of a road corresponding to the segment; and generate, based on the road information, road map information.

According to the present disclosure, it is possible to provide a method and apparatus that accurately generate various types of road information based on route data to support vehicle driving.

The effects of the present disclosure are not limited to those mentioned above, and other effects not mentioned will be clearly understood by those skilled in the art from the following description.

While the exemplary methods of the present disclosure described above are represented as a series of operations for clarity of description, it is not intended to limit the order in which the steps are performed, and the steps may be performed simultaneously or in different order as necessary. To implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus for a vehicle, the method comprising:
performing, based on heading data associated with a plurality of representative regions, clustering of representative points to generate clusters, wherein each representative region comprises a representative point selected from trajectory data obtained from a plurality of vehicles comprising the vehicle;
generating, based on the heading data, connectivity information indicating connection or separation between the clusters;
grouping, based on the connectivity information, the clusters to generate a segment;
generating, based on pieces of the connectivity information associated with the segment, road information comprising driving direction information of a road corresponding to the segment;
generating, based on the road information, road map information;
transmitting, to the vehicle, the road map information; and
causing, based on the transmitted road map information, execution of autonomous driving control of the vehicle.

2. The method of claim 1, wherein the representative point is one of tracking points associated with the corresponding representative region, wherein the tracking points are arranged in the trajectory data at a predetermined interval, and wherein the performing of the clustering of the representative points comprises:
identifying a central position for each of the plurality of representative regions;
generating average heading data of the tracking points, wherein the average heading data comprises an average heading angle for each of the plurality of representative regions;
identifying, for each of the plurality of representative regions, a tracking point that intersects a virtual line perpendicular to the average heading angle of the corresponding representative region; and
grouping, based on the identified tracking points, the plurality of representative regions to generate the clusters.

3. The method of claim 2, wherein the identifying of the tracking point comprises:
identifying, from a plurality of tracking points that intersect with the virtual line, the tracking point, based on:
a distance between closest points in adjacent representative regions being less than or equal to a threshold distance, and
a difference in an average directing angle between the adjacent representative regions being less than or equal to a threshold angle.

4. The method of claim 1, wherein the generating of the connectivity information comprises:
identifying, for each of the representative points in the clusters,
a forward cluster in a heading direction associated with heading data of the representative point, and
a backward cluster in a direction different from the heading direction;
updating the connectivity information, based on at least one of the forward cluster or the backward cluster corresponding to a neighboring cluster, to indicate the connection between the clusters;
updating the connectivity information, based on at least one of the forward cluster or the backward cluster not corresponding to a neighboring cluster, to indicate the separation between the clusters; and
recording, in the connectivity information, the forward cluster and the backward cluster, based on at least one of:
an identifier of an adjacent cluster neighboring the representative point,
an identifier of a cluster in which the representative point is included, or
a disconnection identifier.

5. The method of claim 4, wherein the grouping of the clusters comprises generating the segment by grouping the clusters based on the connectivity information indicating the connection between the clusters.

6. The method of claim 1, wherein the generating of the road information comprises:
generating a center line passing through centers of the clusters in the segment;
generating, based on the connectivity information, driving directions of the representative points, wherein the representative points are arranged on both sides of the center line; and
generating, based on the driving directions, driving direction information of the road corresponding to the representative points.

7. A system comprising one or more computing devices, the system comprising:
a communication interface configured to receive trajectory data obtained from a plurality of vehicles;
a processor; and
a memory storing at least one instruction that, when executed by the processor, causes the system to:
determine, based on the trajectory data, representative points,
generate, based on the representative points, representative regions,
group, based on heading data associated with the representative points, the representative regions to generate clusters,
generate, based on the heading data, connectivity information indicating connection or separation between the clusters,
generate, based on the connectivity information, at least one segment by grouping the clusters,
generate, based on the at least one segment, road information,
generate, based on the road information, road map information,
transmit, to at least one of the plurality of vehicles, the road map information, and
cause, based on the transmitted road map information, autonomous driving control of the at least one of the plurality of vehicles.

8. The system of claim 7, wherein the at least one instruction, when executed by the processor, causes the system to identify, for each of the representative regions, a representative point based on:
a central position of tracking points included in the trajectory data, and
heading data associated with the tracking points.

9. The system of claim 7, wherein the at least one instruction, when executed by the processor, causes the system to determine, based on different heading directions associated with the representative points, the connectivity information.

10. The system of claim 7, wherein the at least one instruction, when executed by the processor, causes the system to generate the at least one segment by grouping clusters that are connected based on the connectivity information.

11. An apparatus for a vehicle, the apparatus comprising:
a processor; and
a memory storing at least one instruction that, when executed by the processor, is configured to cause the apparatus to:
perform, based on heading data associated with a plurality of representative regions, clustering of representative points to generate clusters, wherein each representative region comprises a representative point selected from trajectory data obtained from a plurality of vehicles comprising the vehicle,
generate, based on the heading data, connectivity information indicating connection or separation between the clusters,
group, based on the connectivity information, the clusters to generate a segment,
generate, based on pieces of the connectivity information associated with the segment, road information comprising driving direction information of a road corresponding to the segment,
generate, based on the road information, road map information, transmit, to the vehicle, the road map information, and
cause, based on the transmitted road map information, execution of autonomous driving control of the vehicle.

12. The apparatus of claim 11, wherein the representative point is one of tracking points associated with the corresponding representative region, wherein the tracking points are arranged in the trajectory data at a predetermined interval, and wherein the at least one instruction, when executed by the processor, is configured to cause the apparatus to:
identify a central position for each of the plurality of representative regions;
generate average heading data of the tracking points, wherein the average heading data comprises an average heading angle for each of the plurality of representative regions;
identify, for each of the plurality of representative regions, a tracking point that intersects a virtual line perpendicular to the average heading angle of the corresponding representative region; and
group, based on the identified tracking points, the plurality of representative regions to generate the clusters.

13. The apparatus of claim 12, wherein the at least one instruction, when executed by the processor, is configured to cause the apparatus to identify, from a plurality of tracking points that intersect the virtual line, the tracking point, based on:
a distance between closest points of adjacent representative regions being less than or equal to a threshold distance, and
a difference in an average directing angle between the adjacent representative regions being less than or equal to a threshold angle.

14. The apparatus of claim 11, wherein the at least one instruction, when executed by the processor, is configured to cause the apparatus to:
identify, for each of the representative points in the clusters,
a forward cluster in a heading direction associated with heading data of the representative point, and
a backward cluster in a direction different from the heading direction;
update the connectivity information, based on at least one of the forward cluster or the backward cluster corresponding to a neighboring cluster, to indicate the connection between the clusters;
update the connectivity information, based on at least one of the forward cluster or the backward cluster not corresponding to a neighboring cluster, to indicate the separation between the clusters; and
record, in the connectivity information, the forward cluster and the backward cluster, based on at least one of:
an identifier of an adjacent cluster neighboring the representative point,
an identifier of a cluster in which the representative point is included, or
a disconnection identifier.

15. The apparatus of claim 14, wherein the at least one instruction, when executed by the processor, is configured to cause the apparatus to generate the segment by grouping the clusters based on the connectivity information indicating the connection between the clusters.

16. The apparatus of claim 11, wherein the at least one instruction, when executed by the processor, is configured to cause the apparatus to:
generate a center line passing through centers of the clusters in the segment;
generate, based on the connectivity information, driving directions of the representative points, wherein the representative points are arranged on both sides of the center line; and
generate, based on the driving directions, driving direction information of the road corresponding to the representative points.

17. The apparatus of claim 11, wherein the road information comprises U-turn information corresponding to the segment, and wherein the at least one instruction, when executed by the processor, is configured to cause the apparatus to generate, based on the connectivity information, the U-turn information.

18. The apparatus of claim 11, wherein the road information comprises intersection information, and wherein the at least one instruction, when executed by the processor, is configured to cause the apparatus to generate, based on a cluster arranged at an end of the segment, the intersection information.

19. The apparatus of claim 18, wherein the at least one instruction, when executed by the processor, is configured to cause the apparatus to:
generate, for a plurality of segments generated from the clusters, a plurality of sets of clusters, wherein each set of the plurality of sets of clusters comprises clusters arranged at ends of a corresponding segment; and
determine, based on an overlap of the plurality of sets of clusters, the intersection information, wherein the intersection information indicates an intersection region.

20. The apparatus of claim 19, wherein the at least one instruction, when executed by the processor, is configured to cause the apparatus to postprocess the intersection information to remove, from the plurality of sets of clusters, clusters that overlap the intersection region.
